(19) United States
(12) Patent Application Publication
(10) Pub. No.: US 2021/0120820 A1
(43) Pub. Date: Apr. 29, 2021

(54) HERBICIDAL COMPOSITIONS AND METHODS OF USE THEREOF

(71) Applicant: VALENT U.S.A., LLC, Walnt Creek, CA (US)

(72) Inventors: John Andrew Pawlak, Lansing, MI (US); Eric Miller, San Francisco, CA (US)

(21) Appl. No.: 16/665,217

(22) Filed: Oct. 28, 2019

(51) Int. Cl. A01N 43/80; A01N 43/40; A01N 41/10

(52) U.S. Cl. CPC A01N 43/80; A01N 2300/00; A01N 41/10; A01N 43/40

(57) ABSTRACT

The present invention is directed to an agricultural mixture of pyroxasulfone, mesotrione and clopyralid. The present invention is further directed to a method of controlling weeds comprising applying pyroxasulfone, mesotrione and clopyralid to the weed or an area in need of weed control.

### FIELD OF THE INVENTION

The present invention relates to an agricultural mixture of pyroxasulfone, mesotrione and clopyralid. The present invention also relates to a method of controlling weeds comprising applying pyroxasulfone, mesotrione and clopyralid to the weed or an area in need of weed control.

### BACKGROUND OF THE INVENTION

Unwanted plants, such as weeds, reduce the amount of resources available to crop plants and can have a negative effect on crop plant yield and quality. Unwanted plants in crop plant environments include broadleaves, grasses and sedges.

Herbicides are used to control weeds, in crop environments. Herbicides are expensive, and their use may result in unintentional consequences such as groundwater contamination, environmental damage, herbicide-resistant weeds, and/or human and mammalian health concerns. It is therefore desirable to minimize the amount of herbicides applied to a crop-growing environment or any area in need of weed control.

Weeds may greatly reduce yields of crop plants. For example, a horseweed infestation reportedly was responsible for an 80% reduction in soybean yields. Bruce, J. A., and J. J. Kells, Horseweed (Conyza canadensis) control in no-tillage soybeans (Glycine max) with preplant and preemergence herbicides, Weed Technol. 4:642-647 (1990). Therefore, controlling weeds, and especially grasses and horseweed, is a major concern of crop growers.

Further, horseweed and grasses are becoming resistant to the widely used herbicide glyphosate. As early as 2000, glyphosate-resistant horseweed was reported in Delaware. Glyphosate-resistant horseweed has since been reported in numerous states.

Weeds are also becoming resistant to herbicides that inhibit acetolactate synthase (ALS) and protoporphyrinogen oxidase (PPO). Horseweed has also been reported to be resistant to 2,4-D and dicamba. Accordingly, there is a need for new technology to control weeds that are resistant to commercially available herbicides.

In most fields throughout the Midwest and Mid-South, in-crop burndown applications are the only options for controlling weeds due to weather and timeliness of applications. Growers often find an active ingredient that is effective and the use it repeatedly. Eventually, the weeds become resistant to the active ingredient which leaves no alternatives for weed control other than mechanical removal. Mechanical removal of weeds requires extensive use of resources and is not an option for no-till or highly erodible land.

No-till farming has been increasing in popularity because it has many benefits, including decreased labor time and decreased soil erosion. However, one of the downsides of no-till farming is that weeds are harder to control in these areas because they are not subjected to tilling. Accordingly, there is an increasing need for alternative ways to handle weed infestation.

Pyroxasulfone (3-[[[5-(difluoromethoxy)-1-methyl-3 (trifluoromethyl)-1H-pyrazol-4-yl]methyl]sulfonyl]-4,5-dihydro-5,5-dimethylisoxazole) is an herbicide that has residual weed control. Pyroxasulfone, however, is not very effective for post emergence weed control. Pyroxasulfone is commercially available in a mixture with flumioxazin (Fierce®, available from and a registered trademark of Valent U.S.A. Corporation).

Mesotrione is an herbicide used to control broadleaf weeds in crop fields in both pre- and post-emergent settings. Mesotrione works by blocking an enzyme in the plants that breaks down tyrosine into components necessary for biosynthesis of certain molecules. Mesotrione is commercially available as Callisto® and Tenacity®, available from and a registered trademark of Syngenta.

Clopyralid is another herbicide used to control broadleaf weeds in a post-emergent setting. Clopyralid works by mimicking the auxin plant growth hormone causing uncontrolled plant growth that leads to the plant's death. Clopyralid is commercially available as Stinger® available from and a registered trademark of Dow AgroSciences.

In summary, there is a need for an agricultural mixture that reduces the amount of each herbicides necessary to obtain sufficient weed control while minimizing the harm to crop plants. As more weeds become resistant to herbicides, alternative compositions with high weed control are desired. Further, as no-till farming continues to increase in popularity, there is a greater need for effective herbicides. A mixture with effective weed control and lower dosage rate will lead to increased crop plant yields, and decreased environmental, human, and mammalian health concerns.

### SUMMARY OF THE INVENTION

In one aspect, the present invention is directed to agricultural mixtures comprising pyroxasulfone, mesotrione and clopyralid.

In another aspect, the present invention is directed to a method of controlling weeds comprising applying an effective amount of pyroxasulfone, mesotrione and clopyralid to the weed or an area in need of weed control.

### DETAILED DESCRIPTION OF THE INVENTION

In one embodiment, the present invention is directed to agricultural mixtures comprising pyroxasulfone, mesotrione and clopyralid.

In a preferred embodiment, pyroxasulfone may be present in mixtures of the present invention at a concentration from about 1% to about 97% w/v.

In another preferred embodiment, mesotrione may be present in mixtures of the present invention at a concentration from about 1% to about 97% w/v.

In a preferred embodiment, clopyralid may be present in mixtures of the present invention at a concentration from about 1% to about 97% w/v.

The agricultural mixtures of the present invention can also include one or more additional herbicides.

The agricultural mixtures of the present invention can be formulated in a composition that further comprises one or more excipients selected from the group consisting of solvents, anti-caking agents, stabilizers, anti-foaming agents, slip agents, humectants, dispersants, wetting agents, thickening agents, emulsifiers, anti-freeze agents and preservatives. Other components that enhance the biological activity of these ingredients may optionally be included.

In a preferred embodiment, the mixture of pyroxasulfone, mesotrione and clopyralid may be present in a composition of the present invention at a concentration from about 1% to about 99.9% w/v.

The agricultural mixtures of the present invention can be applied by any convenient means. Those skilled in the art are familiar with the modes of application that include foliar applications such as spraying, chemigation (a process of applying the mixture through the irrigation system), by granular application, or by impregnating the mixture on fertilizer.

The agricultural mixtures of the present invention can be prepared as concentrate formulations or as ready-to-use formulations. The mixtures can be tank mixed.

In another embodiment of the invention, the pyroxasulfone, mesotrione and clopyralid, are applied concurrently to the area in need of weed control. In another embodiment the pyroxasulfone, mesotrione and clopyralid, are applied sequentially to the area in need of weed control.

In a further embodiment, the weed controlled by the compositions of the present invention is at least one of Waterhemp (Amaranthus tuberculatus), Horseweed (Conyza canadensis), Ivyleaf Morningglory (Ipomoea hederacea), Pitted Morningglory (Ipomoea lacunose), Common Ragweed (Ambrosia artemisiifolia), Giant Ragweed (Ambrosia trifida), Large Crabgrass (Digitaria sanguinalis), Palmer Amaranth (Amaranthus palmeri), Broadleaf Signalgrass (Brachiaria platyhylla), Common Barnyardgrass (Echinochloa crus-galli), Yellow Nutsedge (Cyperus esculentus), Eclipta (Eclipta prostrate), Lambsquarters (Chenopodium species), Velvetleaf (Abutilon theophrasti), Foxtail (Setaria species), Giant Foxtail (Setaria faberi) and annual grasses. As used herein, annual grasses include corn, sorghums, wheat, rye, barley, and oats.

In an embodiment, from about 50 to about 150 grams per hectare of pyroxasulfone is applied to the area in need of weed control. In a preferred embodiment, from about 70 to about 110 grams per hectare of pyroxasulfone is applied to the area in need of weed control. In a more preferred embodiment, from about 80 to about 100 grams per hectare of pyroxasulfone is applied to the area in need of weed control. In a most preferred embodiment, from about 85 to about 95 grams per hectare of pyroxasulfone is applied to the area in need of weed control.

In an embodiment, from about 50 to about 150 grams per hectare of mesotrione, or an agriculturally acceptable salt thereof, is applied to the area in need of weed control. In a preferred embodiment, from about 80 to about 120 grams per hectare of mesotrione, or an agriculturally acceptable salt thereof, is applied to the area in need of weed control. In a more preferred embodiment, from about 95 to about 115 grams per hectare of mesotrione, or an agriculturally acceptable salt thereof, is applied to the area in need of weed control. In a most preferred embodiment, from about 100 to about 110 grams per hectare of mesotrione, or an agriculturally acceptable salt thereof, is applied to the area in need of weed control.

In an embodiment, from about 50 to about 150 grams per hectare of clopyralid, or an agriculturally acceptable salt thereof, is applied to the area in need of weed control. In a preferred embodiment, from about 80 to about 120 grams per hectare of clopyralid, or an agriculturally acceptable salt thereof, is applied to the area in need of weed control. In a more preferred embodiment, from about 95 to about 115 grams per hectare of clopyralid, or an agriculturally acceptable salt thereof, is applied to the area in need of weed control. In a most preferred embodiment, from about 100 to about 110 grams per hectare of clopyralid, or an agriculturally acceptable salt thereof, is applied to the area in need of weed control.

The mixtures of the present invention can be applied to any environment in need of weed control. The environment in need of weed control may include any area that is desired to have a reduced number of weeds or to be free of weeds. For example, mixtures of the present invention cay be applied to an area used to grow crop plants, such as a field orchard, or vineyard. Mixtures of the present invention can also be applied to non-agricultural areas in need of weed control such as lawns, golf courses, or parks.

Applicants' compositions and methods can be applied successfully to crop plants and weeds that are resistant to glyphosate, glufosinate, or other herbicides. The composition and methods can also be applied to areas where genetically modified crops (“GMOs”) or non-GMO crops are growing. The term “GMO crops” as used herein refers to crops that are genetically modified.

Throughout the application, the singular forms “a,” “an,” and “the” include plural reference unless the context clearly dictates otherwise.

As used herein, “g ai/ha” is an abbreviation for grams of active ingredient per hectare.

As used herein, all numerical values relating to amounts, weight percentages and the like are defined as “about” or “approximately” each particular value, plus or minus 10%. For example, the phrase “at least 5.0% by weight” is to be understood as “at least 4.5% to 5.5% by weight.” Therefore, amounts within 10% of the claimed values are encompassed by the scope of the claims.

These representative embodiments are in no way limiting and are described solely to illustrate some aspects of the invention.

1. An agricultural mixture comprising pyroxasulfone, mesotrione and clopyralid.

2. The mixture of claim 1, wherein the pyroxasulfone is at a concentration from about 1% to about 97% w/w, wherein w/w denotes weight by total weight of the mixture.

3. The mixture of claim 1, wherein the mesotrione is at a concentration from about 1% to about 97% w/w, wherein w/w denotes weight by total weight of the mixture.

4. The mixture of claim 1, wherein the clopyralid is at a concentration from about 1% to about 97% w/w, wherein w/w denotes weight by total weight of the mixture.

5. An agricultural composition comprising the mixture of claim 1 and one or more excipients selected from the group consisting of a solvent, an anti-caking agent, a stabilizer, an anti-foaming agent, a slip agent, a humectant, a dispersant, a wetting agent, a thickening agent, an emulsifier, an anti-freeze agent and a preservative.

6. The composition of claim 5 wherein the mixture of claim 1 is at a concentration from about 1% to about 99.9% w/v, wherein w/w denotes weight by total weight of the composition.

7. A method of controlling a weed comprising applying an effective amount of pyroxasulfone, mesotrione and clopyralid to the weed or an area in need of weed control.

8. The method of claim 7, wherein pyroxasulfone, mesotrione and clopyralid are applied sequentially or concurrently.
